(19) United States
(12) Patent Application Publication
(10) Pub. No.: US 2006/0222798 A1
(43) Pub. Date: Oct. 5, 2006

(54) Packaging materials and methods of making and using same

(76) Inventor: Jeffrey S. Brandenburg, Greenfield, MA (US)

Correspondence Address: The Wendt Firm, P.C., 34 Driftoak Circle, The Woodlands, TX, 77381, US

(21) Appl. No.: 11/397,062

(22) Filed: Apr. 4, 2006

Related U.S. Application Data
(60) Provisional application No. 60/668,516, filed on Apr. 5, 2005.

(51) Int. Cl. B32B 27/08

(52) U.S. Cl. 428/35.7; 428/35.2

(57) ABSTRACT

Disclosed are materials comprising a thermoformed first layer having a plurality of through passages, and a gas-permeable second layer, at least a portion of which is self-adhered to the first layer. The materials are useful for packaging fresh-cut produce and other foods. It is emphasized that this abstract is provided to comply with the rules requiring an abstract, which will allow a searcher or other reader to quickly ascertain the subject matter of the technical disclosure. It is submitted with the understanding that it will not be used to interpret or limit the scope or meaning of the claims.

### FIELD OF THE INVENTION

The invention is directed to packaging materials and packages made from the materials, particularly, but not limited to, packaging of fresh produce and fresh-cut produce.

### RELATED ART

One of the keys to fresh-cut produce packaging is the modification of the atmosphere inside a fresh-cut produce package. There are a number of ways to accomplish the modification of the internal package atmosphere. One of the most common is through the use of selected polymers in various blends, films and laminations. These combinations of polymers allow O₂ gas and CO₂ gas in and out at a controlled rate. The rate at which gas moves through a polymer film is dependent upon polymer type and surface area and is measured in cc/100 in², or cc/m². Therefore the surface are of the total package is critical.

One of the fastest growing segments of the fresh-cut produce industry is vegetables and fruit packaged in trays with peelable lidding films as closures. This is especially popular with retail fruit packaging in the United States and for both fruit and vegetables throughout the rest of the world. This type of packaging is also widely used in wholesale packaging and food service packaging for hotel and restaurant kitchens.

Due to the thickness and polymer selection required for the tray portion of the package, the O₂ transmission may be reduced to a level that is too low for effective gas transmission when packaging fresh cut produce. Therefore the tray is considered a barrier with respect to the produce and its surface area is not a part of the total surface area calculations. Therefore all of the gas transmission must take place through the lidding material. This causes two potential issues. First, since the surface area of the lid is relatively small compared to the tray the target transmission rates must be very high. Often well above the functional limit of the polymers used in the lidding material. Therefore the lidding material often has to be microperforated, such as described in U.S. Published Pat. App. No. 20040191476, in order to achieve the necessary gas transmission rate. Although this is not necessarily a negative feature, the gas transmission rate properties of a perforated film is significantly different than that of high transmission rate polymers. Many produce items prefer the gas transmission rate properties of engineered polymers. Second, regardless of using either an engineered polymer, or microperforated lidding there is not a uniform gas exchange throughout the package. In other words since all of the gas exchange takes place through the lid there can be microclimates created in portions of the trays, causing a reduced shelf life and product quality.

Therefore, there is a real need to have the tray participate in the gas transmission rate process.

### SUMMARY OF THE INVENTION

In accordance with the present invention, materials, shaped articles made therefrom, and methods of making shaped articles are presented which overcome or reduce problems associated with previous materials.

A first aspect of the invention is a material comprising:
(a) a thermoformed first layer having a plurality of through passages; and
(b) a gas-permeable (which may also be thermoformed) second layer, at least a portion of which is self-adhered to the first layer.

As used herein the term “layer” includes monolayers and multi-layers. Thus, the first and second layers may each comprise one, two, or more than two sub-layers. By “through passages” means the passages offer no barrier to gas flow through the first layer, and extend from a first surface of the first layer all the way to the second surface of the first layer. The through passages may pass essentially straight through the first layer generally transversely, at an angle substantially perpendicular (normal) to the plane of the first layer, although the invention is not so limited. The through passages may be formed mechanically after formation of the first layer itself, or during formation of the first layer. By “self-adhered” means that no further adhesive is necessary, although a secondary adhesive may be used in some embodiments, as well as printed inks, which in some embodiments might function as adhesives. Adhesives may be used, for example, if the second layer comprises a polymer that requires an adhesive layer to bond the other layers together. The second layer may be a single thermoformed layer, or a composite of two or more layers identical or different in composition. Flow passages in the first layer may vary in size (average diameter) in the same layer, and from layer to layer. They may be round, square, rectangular, triangular, oval, and any other cross-section. They may be visible to the naked eye. A typical size may be 0.125 inch (0.32 cm) in diameter for round passages. The through passages may be created during the thermoforming process. The materials of the invention may be formed into shaped articles, such as trays, containers, and the like, adapted to hold food or produce. The final shaped article is considered another aspect of the invention, with or without a lidding material. The through passages may be located on all sides and bottom of the first layer, and may face outside when the materials of the invention are formed into shaped articles such as trays. As the first layer of the materials of the invention acts as a structural support for the contents of the package, the only limit on the amount and size of through passages are that the shaped articles of the invention be able to support what they contain. The first layer may have a clarity enabling vision of the contents of the shaped article.

Materials within the invention include those wherein the first layer is selected from polymers including heterochain polymers such as saturated polyesters, for example, amorphous poly(ethylene terephthalate) (APET); carbon chain polymers, such as polyolefins, for example polypropylene (PP) and high-density poly(ethylene) (HDPE); polymers of vinyl monomers such as poly(vinylchloride) (PVC); poly(styrene) (PS), and mixtures, copolymers, combinations and layered versions thereof, wherein each layer may be a mixture or copolymer of two or more of these. The second layer may be a monolayer, a homopolymer or blends of polymers, or a coextruded film comprised of distinct multiple layers with homopolymer or blends of polymers within each layer. Polymers that may be used in the thermoformable second layer may be selected from carbon chain polymers such as polyolefins, including ethylene-vinyl acetate (EVA); poly(ethyl)methacrylate (EMA), low-density poly(ethylene) (LDPE), high-melt strength LDPEs, metallocenes, such as metallocene poly(ethylenes), also known as plastomer metallocene poly(ethylenes), ultra-low density linear poly(ethylene) (ULLDPE), and linear low density poly(ethylene) (LLDPE), poly(butadiene), and poly(propylene); K-resin, and mixtures, copolymers, and layered versions of two or more of these, wherein each layer may be a mixture, copolymer, or some other combination of these polymers. As used herein the term “copolymer” includes not only those polymers having two different monomers reacted to form the polymer, but two or more monomers reacted to form the polymer. The term also includes block copolymers as well as random copolymers. Where a particular polymer or copolymer may have more than one possible different conformation, such as polypropylene, all conformations are useable, including atactic, syndiotactic, and isotactic conformations. Also cis and trans stereoisomers, such as possible in 1,4,-polybutadiene, are useable in the invention.

Another aspect of the invention are methods of making the materials of the invention, one method comprising:
(a) thermoforming a first layer having a plurality of through passages; and
(b) forming (which may be thermoforming) a second layer onto one surface of the first layer.
   Step (a) may include forming the first layer into a shaped article, such as a shape of a tray or other container shape. In this case, once the final desired shape of first layer is formed, the second layer may be formed onto the “inside” of the first layer and becomes part of the final shaped article, usually in form a tray or container. By “inside” is meant the side of the first layer that is adapted to face toward the package contents. Once the second layer is formed onto or into the first layer it adheres to the “skeleton” of the first layer and covers all of the holes, and, if in the form of a tray, the sealing flange of the tray. Thermoforming may be used for the second step. In using this method, care must be taken in the formulation of the second layer and, if used, the thermoforming process, so that the second layer does not seep out of the though passages of the first layer but rather just covers them up, although a small amount of the second layer polymer may flow into the holes of the first layer.

Another method of the invention comprises:
(a) forming a material having first and second layers, the first layer adapted to have through passages therein, the second layer contacting the first layer; and
(b) forming through passages in the first layer.
   The through passages may be formed in any suitable manner known in the art, such as thermoforming, using a press, or other technique.

Which ever method is used to make the materials and shaped articles of the invention, in the finished combination of breathable second layer and structural first layer with incorporated through passages, all of the gas transmission properties occur through the second layer within the through passages of the first layer.

The second layer may be engineered so that it is thermoformable and adhere to the first layer skeleton. The second layer may have an engineered OTR and becomes the sealing surface for the lidding material. By specifically engineering the gas transmission rate of the second layer, and by knowing the surface area of the through passages throughout the first layer, one can calculate the effective gas transmission rate of the combination of first and second layers, which may be termed a tray or bottom of a container. Once the tray or container bottom gas transmission rate is known, one can engineer a lidding material with specific gas transmission rates, and peel seal properties so that the tray and lidding work in concert to provide an ideal target modified atmosphere to optimize shelf life of the packaged items, such as fresh-cut produce.

The various aspects of the invention will become more apparent after review of the following brief description of the drawings, detailed description, and claims.

### BRIEF DESCRIPTION OF THE DRAWINGS

FIGS. 1-5 are schematic side elevation views of five embodiments of multilayer, gas-permeable materials according to the present invention; and

FIGS. 6-9 are schematic perspective views of shaped articles in the form of trays or containers in accordance with the present invention.

### DETAILED DESCRIPTION

In the following description, numerous details are set forth to provide an understanding of the present invention. However, it will be understood by those skilled in the art that the present invention may be practiced without these details and that numerous variations or modifications from the described embodiments may be possible.

All phrases, derivations, collocations and multiword expressions used herein, in particular in the claims that follow, are expressly not limited to nouns and verbs. It is apparent that meanings are not just expressed by nouns and verbs or single words. Languages use a variety of ways to express content. The existence of inventive concepts and the ways in which these are expressed varies in language-cultures. For example, many lexicalized compounds in Germanic languages are often expressed as adjective-noun combinations, noun-preposition-noun combinations or derivations in Romanic languages. The possibility to include phrases, derivations and collocations in the claims is essential for high-quality patents, making it possible to reduce expressions to their conceptual content, and all possible conceptual combinations of words that are compatible with such content (either within a language or across languages) are intended to be included in the used phrases.

An empirical measurement widely used to characterize controlled-atmosphere packaging materials is the oxygen transport (or oxygen transmission) rate. The oxygen transmission rate (OTR) of any given material is expressed as cc O₂/m²-day-atmosphere. Several related units of measure are also widely used in the field, such as cc O²/100 in²/mil thickness of film/24 hours. Another widely employed means of measuring OTR is described in ASTM D3985-81, which yields an OTR measurement having the units of cc O₂/100 in²/24 hours. (In ASTM D3985-81, the thickness of the film tested in not included in the units expressing the OTR.) The CO₂ transmission rate is also an important physical measurement in certain packaging films. The ratio between the CO₂ transmission rate and the OTR is designated the “beta value.”

As used herein, the phrase “gas-permeability” refers to the transport of gases such as oxygen, nitrogen and carbon dioxide across a membrane. Unless otherwise noted, “gas-permeability” refers to all gases in general.

“Oxygen transport (or transmission) rate (OTR)” as used herein designates oxygen transport rate as measured by ASTM D3985-81 or any equivalent protocol. See also ASTM F1307-02.

“Beta value” refers to the ratio of CO₂ transport rate to OTR. ASTM has not promulgated a standard for measuring carbon dioxide transmission rates. However, equipment for measuring overall gas permeability, oxygen transport rates, and carbon dioxide transmission rates are available commercially, such as the equipment made and sold by MOCON, Inc. (Minneapolis, Minn.).

In accordance with the present invention, materials, shaped articles made using the materials, and methods of making the materials and shaped articles, are presented which overcome or reduce problems associated with previous materials.

A first aspect of the invention is a material comprising:
(a) a thermoformed first layer having a plurality of through passages; and
(b) a gas-permeable second layer, which may be thermoformed at least a portion of which is self-adhered to the first layer.

The second layer may be a single layer, or a composite of two or more layers identical or different in composition, and each may be thermoformed. Flow passages in the first layer may vary in size (average diameter) in the same layer, and from layer to layer. They may be round, square, rectangular, triangular, oval, and any other cross-section. They may be visible to the naked eye. A typical size may be 0.125 inch (0.32 cm) in diameter for round passages. The through passages may be created during the thermoforming process. The materials of the invention may be formed into shaped articles, such as trays, containers, and the like, adapted to hold food or produce. The final shaped article is considered another aspect of the invention, with or without a lidding material. The through passages may be located on all sides and bottom of the first layer, and may face outside when the materials of the invention are formed into shaped articles such as trays. As the first layer of the materials of the invention acts as a structural support for the contents of the package, the only limit on the amount and size of through passages are that the shaped articles of the invention be able to support what they contain. The first layer may have a clarity enabling vision of the contents of the shaped article.

Materials within the invention include those wherein the first layer is selected from polymers including amorphous poly(ethylene terephthalate) (APET), polypropylene (PP), high-density poly(ethylene) (HDPE), poly(vinylchloride) (PVC), poly(styrene) PS, and mixtures, copolymers, combinations and layered versions thereof, wherein each layer may be a mixture or copolymer of two or more of these. The second layer may be a mono layer, a homopolymer or blends of polymers, or a coextruded film comprised of distinct multiple layers with homopolymer or blends of polymers within each layer. Polymers that may be used in the thermoformable second layer may be selected from ethylene-vinyl acetate (EVA), poly(ethyl)methacrylate (EMA), high-melt strength LDPEs, and metallocenes such as metallocene poly(ethylenes), also known as plastomer metallocene poly(ethylenes), low-density poly(ethylene) (LDPE), ultra-low density linear poly(ethylene) (ULLDPE), linear low density poly(ethylene) (LLDPE), K-resin, PP, poly(butadiene), and mixtures, copolymers, and layered versions of two or more of these, wherein each layer may be a mixture, copolymer, or some other combination of these polymers. As used herein the term “copolymer” includes not only those polymers having two different monomers reacted to form the polymer, but two or more monomers reacted to form the polymer.

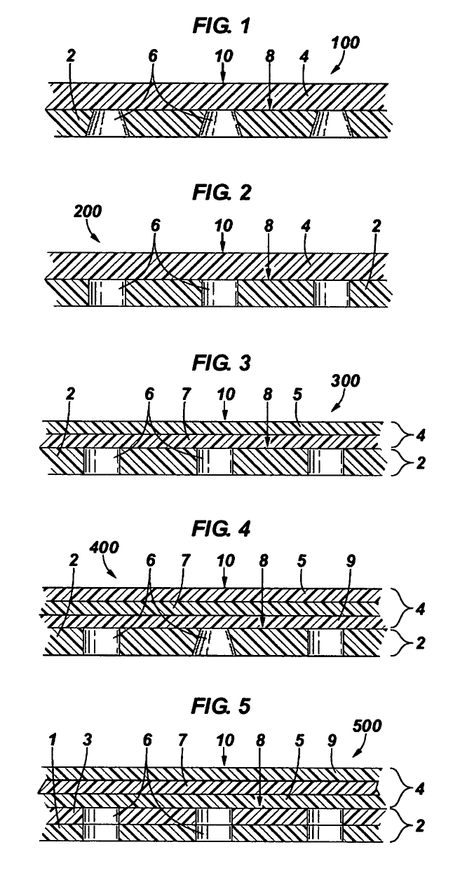

Referring now to the figures, FIGS. 1-5 are schematic side elevation views of four embodiments of multilayer, gas-permeable materials according to the present invention. FIG. 1 illustrates a side elevation view of a first embodiment 100, having a first layer 2 and a second layer 4. First layer has a plurality of through passages 6, and second layer 4 has no through passages, although it is permeable to oxygen and carbon dioxide. First layer 2 may be adhered directly to second layer 4, with no auxiliary adhesive, at locations 8 where there is no opening in first layer 2. Alternatively, there may be in certain embodiments an adhesive layer between layers 2 and 4, which may be co-extensive with t layers 2 and 4, or only extend to certain areas, for example, edge areas. Second layer has a surface 10 that is adapted to face a food product.

FIG. 2 illustrates a side elevation view of a second embodiment 200 of a material of the invention similar to embodiment 100, except that through passages 6 are cylindrical in shape, and have varying diameters.

FIG. 3 illustrates a side elevation view of a third embodiment 300 of a material of the invention, wherein second layer 4 is comprised of two layers 5 and 7, which may be the same or different in composition, thickness, and gas permeability. Layers 5 and 7 may be combined by any process, such as co-extrusion, thermoforming, laminating, and the like.

FIG. 4 illustrates a side elevation view of a fourth embodiment 400 of a material of the invention, wherein layer 4 is comprised of three separate layers, 5, 7, and 9, which may be the same or different in composition, thickness, and gas permeability. Layers 5, 7, and 9 may be combined by any process, such as co-extrusion, thermoforming, laminating, and the like.

FIG. 5 illustrates a side elevation view of a fourth embodiment 400 of a material of the invention, wherein layer 4 is comprised of three separate layers, 5, 7, and 9, which may be the same or different in composition, thickness, and gas permeability. Layers 5, 7, and 9 may be combined by any process, such as co-extrusion, thermoforming, laminating, blending, and the like. This embodiment also illustrates that layer 2 may comprise more than one layer, here comprising two sub-layers 1 and 3, which may be the same or different in composition (including blends) and thickness.

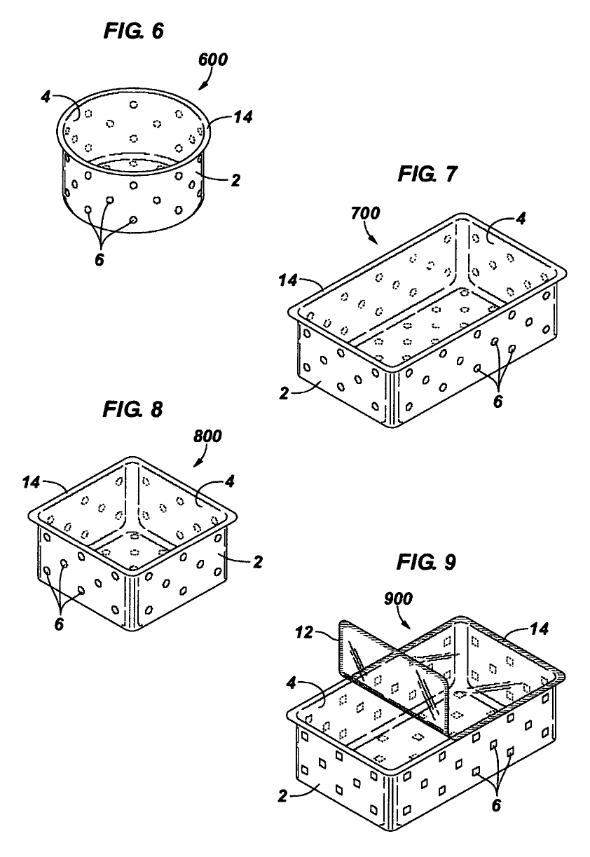

FIG. 6 illustrates a perspective view of a first shaped article 600 of the invention. Shaped article 600 comprises a round sheet of material comprised of two layers, 2 and 4, in accordance with a material embodiment of the invention forming a tray or container. Layer 4 is apparent only through passages 6. A bottom of the tray or container also may have through passages 6, illustrated in phantom.

FIG. 7 illustrates a perspective view of a second shaped article 700 of the invention. Shaped article 700 comprises a rectangular tray having four sides and a bottom. The four sides may comprise a rectangular sheet of material comprised of two layers, 2 and 4, in accordance with a material embodiment of the invention forming a tray or container. Layers 2 and 4 also form a bottom (shown in phantom) of this tray. Layer 4 is apparent only through passages 6, and is illustrated by mottling. The bottom of the tray or container also may have through passages 6 (shown in phantom).

FIG. 8 illustrates an embodiment 800 essentially the same as embodiment 700 of FIG. 7 except that it has the shape of a square box or tray having four sides and a bottom, each of the sides and the bottom having a plurality of through passages 6, with second layer 4 shown only through the passages 6.

FIG. 9 illustrates an embodiment 900 essentially similar to embodiment 700 of FIG. 7 except that through passages 6 are in the shape of squares.

Although it will depend a great deal on the item being packaged, and the properties of the lidding material, the second layer may have an OTR generally ranging from about 200 to about 900 cc/100 in², and a beta value generally ranging from about 2 to about 5. These values for the second layer will be used in combination with the permeability of the lidding material, when the material of the invention is combined with a lidding material, to achieve a total engineered OTR of a package or container. First layer 2 may have a thickness ranging from about 10 mils to about 25 mils, while second layer 4 is generally less thick than first layer 2, although this is strictly not required. Second layer 4 may have a thickness ranging from about 1 mil to about 3.5 mils. The thicknesses of these layers may be uniform through the respective layers, or vary within each layer.

The material may be formed first into the layered material, which is not limited to two layers, or the first layer may be thermoformed into a tray shape, and then the second layer formed, preferably thermoformed, inside of the first layer. Once the final desired shape is formed the thinner second layer is formed into the first layer and becomes part of the final shaped article, usually in form a tray or container. The second layer may be a mono layer, a homopolymer or blends of polymers, or a coextruded film comprised of distinct multiple layers with homopolymer or blends of polymers within each layer. Polymers that may be used in the second layer, and which may be thermoformed or formed by another process, include: ethylene-vinyl acetate (EVA), low-density poly(ethylene) (LDPE), metallocenes, ultra-low density linear poly(ethylene) (ULLDPE), linear low density poly(ethylene) (LLDPE), K-resin, PP, and poly(butadiene). Once the second layer is formed onto or into the first layer it adheres to the skeleton of the first layer and covers all of the holes, and, if in the form of a tray, the sealing flange of the tray. Care must be taken in the formulation of the second layer and, if used, the thermoforming process, so that the second layer does not seep out of the through passages of the first layer but rather just covers them up, although a small amount of the polymer used to make the second layer may flow into the holes of the first layer.

In the finished combination of first and second layers, all of the gas transmission properties occur through the film within the cut out section of the first layer. The second layer, typically a polymeric film, may be engineered so that it is thermoformable, will self-adhere to the tray skeleton, has an engineered OTR and becomes the sealing surface for the lidding material. By specifically engineering the gas transmission rate of the second layer, and by knowing the surface area of the through passages throughout the article, one can calculate the effective gas transmission rate of the article. Once the tray gas transmission rate is known, one can engineer a lidding material with specific gas transmission rates, and peel seal properties so that the first and second layers work in concert with the lidding material to provide an optimum ideal target modified atmosphere to optimize shelf life of the packaged food, which may be fresh-cut produce.

In one method of making materials of the invention, the first layer has the through passages formed in it prior to its being adhered to the second layer. Various methods can be used to introduce the through passages into the first layer. Such methods include laser cutting, thermoforming with open areas, and mechanical punches using hot or cold needles.

The second layer for use in the present invention may be fabricated from homopolymers, copolymers, and/or blends of alpha-monoolefins having from 2 to 10 carbons, and most preferably from 2 to 5 carbons. Thus, for example, the films can be fabricated from polymeric materials (homopolymers, copolymers or blends) of poly(C1-C10-alkylene), poly(C2-C10-methylene diamine), polystyrene, poly(C1-C10-alkylene)-vinyl acetate, and poly(C1-C10-alkylene)-vinyl alcohol. This list is exemplary and not exclusive. Examples of suitable second layer materials include, but are not limited to, poly(ethyl)methacrylate (EMA), high-melt strength LDPEs, and metallocene poly(ethylenes), also known as plastomer metallocene poly(ethylenes), poly(C1-C10-alkylene terephthalate), poly(C1-C10-alky-lene)-methacrylic acid, and polycarbonates. Certain embodiments may have as a second layer a co-extruded film of three layers: EMA, high-melt strength LDPE, and a metallocene, such as a metallocene poly(ethylene). In this latter embodiment, the EMA layer may face the first layer, although the invention is not so limited. In certain embodiments, each sublayer may have multiple resins. For example, in the embodiment just discussed, where the second layer is a three layer combination of EMA, a high-melt strength poly(ethylene) and a metallocene poly(ethylene), each of these three sub-layers may be comprised of one, two, three, or possibly four or more resins.

Examples of suitable homopolymers that may be used in the present invention, for either the first or second layer, include poly(ethylene), poly(propylene), poly(1-butene), poly(3-methyl-1-butene), poly(3-methyl-1-pentene), poly(3-methyl-1-hexene), poly(4-methyl-1-hexene), poly(4,4-dimethyl-1-hexene), and the like.

Suitable copolymers for either the first or second layer that can be used in the present invention include (but are not limited to) ethylene-co-propylene, ethylene-co-1-butene, ethylene-co-1-pentene, ethylene-co-1-hexene, ethylene-co-1-octene, ethylene-co-1-heptene, ethylene-co-1-nonene, ethylene-co-1-decene, and the like.

Examples of other homo- and copolymers that can be used as either the first or second layers (or both) in the present invention include poly(ethylene terephthalate), poly(butylene terephthalate), poly(C2-C-methylene diamines) (e.g. Nylon), polystyrene, ethylene-vinyl acetate copolymers, ethylene-methacrylic acid copolymers (i.e., ionomers), ethylene-vinyl alcohol copolymers, and polycarbonate.

Examples of blends that can be used in the present invention (for either the first or second layers) include blends of homopolymers such as those listed hereinabove (e.g., a blend of polyethylene and polypropylene) or blends of a homopolymer and a copolymer (e.g., a blend of polyethylene with ethylene-co-octene copolymer). Blends of two copolymers can also be used (e.g., a blend of ethylene-co-1-octene and ethylene-co-1-butene).

The second layer, if a multi-layered structure, may comprise metalized, holographic, or diffraction films.

The first and second layers may contain any number of conventional additives such as processing aids, antioxidants, colorants, anti-blocking agents, and the like, as long as the general material and physical properties of the first and second layers are not compromised. Very generally, the first layer is desired to be supporting and fairly strong, and the second layer flexible and breathable within the limits discussed herein. Assuming these objectives are met, for example, the first and/or second layers may contain processing aids such as calcium stearate, zinc stearate, oleic acid, stearic acid, and the like. The first and/or second layers may also include antioxidant stabilizers, such as tetrakis(methylene (3,5-di-t-butyl-4-hydroxyhydrocinnamate))methane, tris(2,4-di-t-butylphenyl)phosphite, dilaurylthio-dipropionate, and N,N′-diphenyl-p-phenylenediamine. The first and/or second layers may include anti-blocking agents, such as diatomaceous earth. The above list of additives is exemplary only.

There are a host of national and international companies that manufacture and market suitable finished layers and/or compounding resins for use in the present invention. They include, for example, ExxonMobil Chemical Company (Baton Rouge, La.), DuPont (Wilmington, Del.), Mitsubishi Polyester Film (Greer, S.C.), SKC Global (Hong Kong), GE Plastics (Pittsfield, Mass.), and Honeywell Specialty Materials Division (Morristown, N.J.). Other companies that supply suitable materials for use in the present invention include Pliant Corporation (formerly Huntsman, Schaumburg, Ill.), New England Extrusion, Inc. (Turners Falls, Mass.), Charter Films (Superior, Wis.), Flex Tech (San Marcos, Tex.), and Alcan Thermoplastic, Ltd, Chelmsford, UK. Suitable lidding materials include those material produced by FFP Packaging Solutions, Northampton, UK

Regarding the calculation of OTR for the second layer, if a multilayer structure, once the OTRs of the individual films are known, the total OTR for the second layer can be accurately predicted by the following equation:
OTRₜₒₜₐₗ=1/(1/OTR_{first sub-layer}+1/OTR_{second sub-layer}+1/OTR_{Nth sub-layer})

As can be seen from this equation, as the OTR of one of the sub-layers gets larger, its contribution to the total OTR gets smaller. In other words, the contribution of the “high-breathing” sub-layers to the OTR of the entire structure becomes nil or insignificantly small as the OTR of the “high-breathing” layers get larger and larger.

The materials of the present invention may to be used to make packages and for packaging food articles. The preferred utility is to use the film in packaging any and all fruits and vegetables, especially respirating, fresh-cut vegetables and fresh-cut fruit. Fruits that may be packaged using the materials of the invention include, but are not limited to blueberries, raspberries, cranberries, blackberries, strawberries, citrus produce such as lemons, limes, stone fruits, grapes, melons, non-citrus fruits, which may or may not be considered “exotic” fruits, such as kiwi, mango, and passion fruit, mixtures of two or more of these. Vegetables that may be packaged using the materials of the invention include, but are not limited to, root vegetables, tuber vegetables, and leaf vegetables. Examples include carrots, broccoli, onions, potatoes, spinach, lettuce, cauliflower, blends, and other high respiring products, avocadoes, and the like.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims. In the claims, no clauses are intended to be in the means-plus-function format allowed by 35 U.S.C. § 112, paragraph 6, unless “means for” is explicitly recited together with an associated function without any structure being recited. “Means for” clauses are intended to cover the structures described herein as performing the recited function and not only structural equivalents, but also equivalent structures.

What is claimed is:

1. A material comprising:
(a) a thermoformed first layer having a plurality of through passages; and
(b) a gas-permeable second layer, at least a portion of which is self-adhered to the first layer.

2. The material of claim 1, further comprising features selected from 1) an adhesive layer disposed between at least a portion of the first and second layers; 2) ink disposed between the first layer and the second layer; 3) an adhesive layer and ink disposed between the first layer and the second layer; 4) wherein the plurality of through passages has an average diameter ranging from about 1/16 inch to about 1 inch; 5) an OTR ranging from about 200 to about 900 cc/100 in²; a beta value ranging from about 2 to about 5; and 6) combinations thereof

3. A shaped article made using the material of claim 1.

4. The shaped article of claim 3 in the form of a container or package.

5. The shaped article of claim 4 including a lidding material, wherein the material and lidding material are selected so that the OTR and beta value of the material and the lidding material are adapted to provide optimal ideal values dependent upon the contents intended to be stored in the container.

6. A method comprising steps selected from:
(a) thermoforming a first layer having a plurality of through passages; and
(b) forming a second layer onto one surface of the first layer; and
(a)′ forming a material having first and second layers, the first layer adapted to have through passages therein, the second layer contacting the first layer; and
(b)′ forming through passages in the first layer.

7. A method comprising:
packaging a food product selected from one or more fruits, one or more vegetables, and any combination of fruits and vegetables using a material comprising a thermoformed first layer having a plurality of through passages, and a gas-permeable second layer, at least a portion of which is self-adhered to the first layer.

8. The method of claim 7 wherein the second layer is thermoformed.

9. The method of claim 7 comprising forming a container comprising the material, placing the food product in the container, and sealing the package with a lidding material.

10. The method of claim 9 wherein the material of the container is used in combination with the lidding material to achieve a total engineered OTR of the container.

11. The material of claim 1 comprising a thermoformed, gas-permeable second layer, at least a portion of which is self-adhered to the first layer.

12. The material of claim 11, further comprising features selected from 1) an adhesive layer disposed between at least a portion of the first and second layers; 2) ink disposed between the first layer and the second layer; 3) an adhesive layer and ink disposed between the first layer and the second layer; 4) the plurality of through passages has an average diameter ranging from about 1/16 inch to about 1 inch; and 5) combinations thereof.

13. The material of claim 11, further comprising the material comprising an OTR ranging from about 200 to about 900 cc/100 in².

14. The material of claim 11, further comprising a beta value ranging from about 2 to about 5.

15. A shaped article made using the material of claim 11.

16. The shaped article of claim 15 in the form of a container or package.

17. The shaped article of claim 16 including a lidding material, wherein the material and lidding material are selected so that the OTR and beta value of the material and the lidding material are adapted to provide optimal ideal values dependent upon the contents intended to be stored in the container.

18. The method of claim 6 comprising thermoforming the second layer onto one surface of the first layer.

19. The method of claim 18 comprising forming a container comprising the material, placing the food product in the container, and sealing the package with a lidding material.

20. The method of claim 19 wherein the material of the container is used in combination with the lidding material to achieve a total engineered OTR of the container.
